(19) United States
(12) Patent Application Publication
(10) Pub. No.: US 2025/0256462 A1
(43) Pub. Date: Aug. 14, 2025

(54) CONTINUOUS FEEDING SYSTEM FOR THREE-DIMENSIONAL PRINTING

(71) Applicant: Mighty Buildings, Inc., Oakland, CA (US)

(72) Inventors: Sergey Naumov, Moscow (RU); Michael Byvald, Monterrey (MX)

(21) Appl. No.: 18/440,755

(22) Filed: Feb. 13, 2024

(51) Int. Cl. B29C 64/393; B29C 64/106; B29C 64/209; B29C 64/255; B29C 64/295; B29C 64/314; B29C 64/321; B29C 64/343; B29C 64/357; B33Y 10/00; B33Y 30/00; B33Y 40/10; B33Y 50/02

(52) U.S. Cl. CPC B29C 64/393; B29C 64/106; B29C 64/255; B29C 64/295; B29C 64/314; B29C 64/321; B29C 64/343; B29C 64/357; B33Y 10/00; B33Y 30/00; B33Y 40/10; B33Y 50/02; B29C 64/209

(57) ABSTRACT

A 3D printing system includes a print head and a continuous feeding system that supplies fluid printing material into the print head continuously as the print head moves and extrudes the printing material. The continuous feeding system can include a feeding tank that holds and dispenses the printing material, a main feeding line that passes the printing material from the feeding tank, a valve that stops and allows the flow of printing material through the main feeding line, a main pump that alters the flow rate of the printing material passing through the main feeding line, a secondary feeding line that delivers printing material from the main feeding line into the print head, an intermediate pump that alters the flow rate of the printing material passing through the secondary feeding line, and a return line that delivers excess printing material from the main feeding line back into the feeding tank.

### TECHNICAL FIELD

The present disclosure relates generally to additive manufacturing, and more particularly to three-dimensional (“3D”) printing using fluid printing materials.

### BACKGROUND

Recent advancements in additive manufacturing based on layer-by-layer 3D printing have resulted in custom design diversification, efficient manufacturing without a complex supply chain, low waste, and high automation, among other advantages. One of many advancements includes the use of a movable print head within a 3D printing system, which can allow for automated 3D printing at relatively high speeds. Use of a moving print head, however, can exacerbate various issues that already exist due to outdated material feeding systems and the highly viscous and complex nature of typical fluid 3D printing materials.

Conventional 3D printing systems feed the printer directly with fluid printing materials, and many viscous and complex 3D printing materials tend to settle in the feeding pipelines in typical material feeding systems. As a result, any stoppage of a 3D printing process commonly leads to a failure of the entire material feeding system, after which it becomes necessary to clean the feeding system thoroughly. It is also difficult to use relatively large volume tanks (e.g., more than 50 liters) to feed a 3D printer due to the viscous and complex nature of typical 3D printing materials. Furthermore, direct material feeding systems often offer little to no control of sedimentation and/or air bubbles in the printing materials in the packaging drums and storage tanks, which can result in undesirable printing inconsistencies and defects.

Traditional direct material feeding systems for 3D printing also tend to be inflexible, which results in further problems for the overall 3D printing system and process. For example, any change in the characteristics of the fluid printing material being used can lead to a significant restructuring of a printer used with a direct material feeding system. Constant adaptations of the material feeding system itself are also typically necessary when the printing materials to be used change significantly. Direct material feeding systems also struggle to maintain a constant pressure at the printer due to material complexities. Sufficient pressure buildup or inconsistency can cause the printing material to delaminate, which then causes the printing process to stop.

Unfortunately, adding a moving print head can aggravate these issues and can also add new problems to the direct material feeding system and to the overall printing process. For example, a moving print head can by itself result in additional disruptions in the flow of fluid printing material into the printing head, which can then result in undesirable inconsistencies in the printing material as it is extruded from the moving printing head. This is particularly true in cases where the print head moves vertically between low and high elevations during a continuous printing process, since any change in the elevation of the print head automatically results in a change in pressure of the fluid printing material entering the print head through a feeding line. Such added pressure changes due to print head elevation changes then further limit the ability to print objects continuously with a consistent flow and reliable output of fluid printing material, and this can also limit the speed at which many complex objects are printed.

Although traditional ways of 3D printing with moving print heads have worked well in the past, improvements are always helpful. In particular, what is desired are material feeding systems for 3D printing that provide continuous and reliable supplies of fluid printing material while a 3D print head is moving during a continuous 3D printing process.

### SUMMARY

It is an advantage of the present disclosure to provide material feeding systems for 3D printing that provide continuous and reliable supplies of fluid printing material while a 3D print head is moving during a continuous 3D printing process. The disclosed features, apparatuses, systems, and methods provide overall 3D printing systems that include improved features and ways to feed highly viscous and complex fluid printing materials into a moving print head in a stable and reliable manner such that continuous printing can take place for longer periods of time. These advantages can be accomplished in multiple ways, such as by introducing return lines, multiple pressure regulation devices in the feeding and return lines, and continuous mixing and material control components in the material feeding systems, among other possible features.

In various embodiments of the present disclosure, a 3D printing system can include a print head and a continuous feeding system. The print head can be configured to extrude fluid printing material during a 3D printing process and can also be configured to move in multiple directions including changing elevation while continuously extruding the fluid printing material. The continuous feeding system can be coupled to the print head and can be configured to supply the fluid printing material into the print head continuously as the print head moves and extrudes the fluid printing material. The continuous feeding system can include a feeding tank configured to hold and dispense the fluid printing material, a main feeding line coupled to an outlet of the feeding tank and configured to pass the fluid printing material from the outlet, a first flow regulation device located along the main feeding line, a second flow regulation device located along the main feeding line, a secondary feeding line coupled to the main feeding line and configured to deliver fluid printing material from the main feeding line into the print head, a third flow regulation device located along the secondary feeding line, and a return line coupled to the main feeding line and configured to deliver excess fluid printing material from the main feeding line back into the feeding tank. The first flow regulation device can be configured to stop and to allow the flow of the fluid printing material through the main feeding line. The second flow regulation device can be configured to alter the flow rate of the fluid printing material passing through the main feeding line. The third flow regulation device can be configured to alter the flow rate of the fluid printing material passing through the secondary feeding line.

In various detailed embodiments, the system can be configured for the printing of 3D-printed building elements. The first flow regulation device can be a valve, and the second and third flow regulation devices can be variable power progressive cavity pumps. At least a portion of the main feeding line, the return line, or both can include flexible tubing that is configured to move based on movement of the print head. Also, the feeding tank can have a conically shaped bottom and can have a volume of at least 50 liters. The continuous feeding system can also include a first pressure sensor configured to detect a pressure of the fluid printing material passing through the main feeding line, a second pressure sensor configured to detect a pressure of the fluid printing material passing through the return line, and a processing component in communication with the first pressure sensor, the second pressure sensor, and the third flow regulation device. The processing component can be configured to receive automatically inputs from the first and second pressure sensors and to adjust automatically an output of the third flow regulation device based on the received inputs. Adjustment of the third flow regulation device output can result in the fluid printing material being continuously supplied into the print head at a substantially constant pressure and flow rate despite movement of the print head.

In further detailed embodiments, the continuous feeding system can also include a mixing blade located within the feeding tank and configured to mix the fluid printing material continuously within the feeding tank during the 3D printing process and a mixing blade motor coupled to and configured to rotationally drive the mixing blade. Combined operation of the print head, the second flow regulation device, the third flow regulation device, the mixing blade, and the mixing blade motor can result in the continuous movement of substantially all fluid printing material in the print head, the feeding tank, the main feeding line, the secondary feeding line, and the return line during the 3D printing process. In various arrangements, the continuous feeding system can also include one or more source lines configured to deliver one or more component materials of the fluid printing material from one or more sources into the feeding tank, and one or more source pumps configured to pump the one or more component materials through the one or more source lines. The one or more sources can include a material drum, and the continuous feeding system can also include a material drum heater configured to heat the material drum, one or more heating components configured to heat one or more additional continuous feeding system components between the material drum and the print head, and one or more thermal insulation components configured to thermally insulate one or more additional continuous feeding system components between the material drum and the print head to maintain a heated temperature of the fluid printing material. The continuous feeding system can also include one or more filters configured to filter large particles from the one or more component materials before the one or more component materials are delivered into the feeding tank, as well as a degasser located within the feeding tank and configured to remove gas bubbles from the fluid printing material within the feeding tank.

In further embodiments of the present disclosure, a continuous feeding system configured to supply fluid printing material within a 3D printing system can include a feeding tank, a main feeding line, a valve, a main pump, a secondary feeding line, an intermediate pump, and a return line. The feeding tank can be configured to hold and dispense the fluid printing material. The main feeding line can be coupled to an outlet of the feeding tank and can be configured to pass the fluid printing material from the outlet. The valve can be located along the main feeding line and can be configured to stop and to allow the flow of the fluid printing material through the main feeding line. The main pump can be located along the main feeding line and can be configured to alter the flow rate of the fluid printing material passing through the main feeding line. The secondary feeding line can be coupled to the main feeding line and can be configured to deliver the fluid printing material from the main feeding line into a print head of the 3D printing system. The intermediate pump can be located along the secondary feeding line and can be configured to alter the flow rate of the fluid printing material passing through the secondary feeding line. The return line can be coupled to the main feeding line and can be configured to deliver excess fluid printing material from the main feeding line back into the feeding tank. In some arrangements, the continuous feeding system can be configured to supply the fluid printing material continuously at a substantially constant flow and pressure to the print head while the print head extrudes the fluid printing material therefrom continuously as it moves between different elevations.

In various detailed embodiments, at least a portion of the main feeding line, at least a portion of the return line, or both, can include flexible tubing that is configured to move based on movement of the print head. The continuous feeding system can also include a first pressure sensor configured to detect a pressure of the fluid printing material passing through the main feeding line, a second pressure sensor configured to detect a pressure of the fluid printing material passing through the return line, and a processing component in communication with at least the first pressure sensor, the second pressure sensor, and the intermediate pump. The processing component can be configured to receive automatically inputs from the first and second pressure sensors and to adjust automatically an output of the intermediate pump based on the received inputs. The continuous feeding system can also include an agitation component located within the feeding tank that can be configured to agitate or mix the fluid printing material continuously within the feeding tank during the 3D printing process, one or more source lines that can be configured to deliver one or more component materials of the fluid printing material from one or more sources into the feeding tank, wherein at least one of the sources can be a material drum, one or more source pumps that can be configured to pump the one or more component materials through the one or more source lines, a material drum heater that can be configured to heat the material drum, one or more heating components that can be configured to heat one or more additional continuous feeding system components between the material drum and the print head, one or more thermal insulation components that can be configured to thermally insulate one or more additional continuous feeding system components between the material drum and the print head to maintain a heated temperature of the fluid printing material, one or more filters that can be configured to filter large particles from the one or more component materials before the one or more component materials are delivered into the feeding tank, and/or a degasser that can be located within the feeding tank and that can be configured to remove gas bubbles from the fluid printing material within the feeding tank.

In still further embodiments of the present disclosure, methods of providing fluid printing material to a 3D printing system are provided. Pertinent process steps can include pumping fluid printing material from a feeding tank through a main feeding line using a main pump located on the main feeding line, diverting a first portion of the fluid printing material from the main feeding line through a secondary feeding line and into a print head of the 3D printing system using an intermediate pump located on the secondary feeding line, returning a second portion of the fluid printing material from the main feeding line through a return line and back into the feeding tank, detecting fluid pressures in the main feeding line and the return line, adjusting an output of the intermediate pump based on the detected fluid pressures in the main feeding line and the return line, and providing the fluid printing material continuously at a substantially constant flow and pressure from the intermediate pump to the print head by way of the adjusted output. Some or all of the process steps can be performed automatically, such as by way of an automated system using one or more processing components.

In various detailed embodiments, the fluid printing material can be provided continuously at a substantially constant flow and pressure while the print head extrudes the fluid printing material continuously therefrom as it moves between different elevations. Additional process steps can include maintaining one or more source materials used to form the fluid printing material, pumping the one or more source materials through one or more source lines into the feeding tank, filtering the one or more source materials to remove large particulate matter, degassing the one or more source materials, the fluid printing material in the feeding tank, or both, mixing the one or more source materials in the feeding tank to form the fluid printing material, stirring the fluid printing material in the feeding tank, actuating an output valve coupled to an outlet of the feeding tank to allow the fluid printing material to pass from the feeding tank therethrough, extruding the fluid printing material from the print head, and/or adjusting an elevation of the print head while extruding the fluid printing material therefrom. In some arrangements, some or all of the various process steps can be performed simultaneously, can be repeated, or both.

Other apparatuses, methods, features, and advantages of the disclosure will be or will become apparent to one with skill in the art upon examination of the following figures and detailed description. It is intended that all such additional apparatuses, methods, features and advantages be included within this description, be within the scope of the disclosure, and be protected by the accompanying claims.

### BRIEF DESCRIPTION OF THE DRAWINGS

The included drawings are for illustrative purposes and serve only to provide examples of possible structures and arrangements for the disclosed apparatuses, systems and methods of use for continuous feeding systems for 3D printing. These drawings in no way limit any changes in form and detail that may be made to the disclosure by one skilled in the art without departing from the spirit and scope of the disclosure.

FIG. 1 illustrates in front perspective view an example print head of a 3D printing system according to one embodiment of the present disclosure.

FIG. 2 illustrates in schematic diagram format an example continuous feeding system for 3D printing according to one embodiment of the present disclosure.

FIG. 3 illustrates a flowchart of an example summary method of providing fluid printing material to a 3D printing system according to one embodiment of the present disclosure.

FIG. 4A illustrates in schematic diagram format an example continuous feeding system for 3D printing feeding a print head at a low elevation according to one embodiment of the present disclosure.

FIG. 4B illustrates in schematic diagram format the continuous feeding system of FIG. 4A feeding the print head at a high elevation according to one embodiment of the present disclosure.

FIG. 5 illustrates a flowchart of an example detailed method of 3D printing a building component using a variable elevation print head and a continuous flow of fluid printing material according to one embodiment of the present disclosure.

### DETAILED DESCRIPTION

Exemplary applications of apparatuses, systems, and methods according to the present disclosure are described in this section. These examples are being provided solely to add context and aid in the understanding of the disclosure. It will thus be apparent to one skilled in the art that the present disclosure may be practiced without some or all of these specific details provided herein. In some instances, well known process steps have not been described in detail in order to avoid unnecessarily obscuring the present disclosure. Other applications are possible, such that the following examples should not be taken as limiting. In the following detailed description, references are made to the accompanying drawings, which form a part of the description and in which are shown, by way of illustration, specific embodiments of the present disclosure. Although these embodiments are described in sufficient detail to enable one skilled in the art to practice the disclosure, it is understood that these examples are not limiting, such that other embodiments may be used, and changes may be made without departing from the spirit and scope of the disclosure.

The present disclosure relates in various embodiments to features, apparatuses, systems, techniques, and methods for providing continuous and reliable supplies of complex and highly viscous fluid printing materials to a print head during a continuous 3D printing process. The various disclosed features, systems, and methods provide overall 3D printing systems that include improved features and ways to feed fluid printing materials into a moving print head in a stable and reliable manner such that continuous printing can take place for longer periods of time. These advantages can be accomplished in multiple ways, such as by introducing return lines, multiple pressure regulation devices in the feeding and return lines, and continuous mixing and material control components in the material feeding systems, among other possible features.

The present disclosure can be applied to all types of 3D printing, such as construction printing, for example, where it is desirable to supply 3D printers with mixtures of complex fluid printing materials. The disclosed continuous feeding system can work with a wide range of high-viscosity printing material mixtures such as resin-based, concrete, or geopolymer, among other possible mixtures, and can support operations involving the continuous preparation and supply of materials to the print head of a 3D printer. Unlike feeding systems that supply simple fluids and materials, the disclosed continuous feeding systems are able to work with complex composite mixtures that are highly viscous to still provide fluid material flows at substantially constant flow rates and pressures with substantially constant or uniform homogeneity in the complex and viscous fluid printing materials that are continuously fed into a 3D printing system.

As noted above, conventional direct feeding systems had numerous problems with feeding complex and highly viscous fluid printing materials into a print head or other printing component of a 3D printing system. These included the settling of source materials in packing barrels or other source containers, high air bubble contents in the source materials and fluid printing material mixtures, the settling or delamination of materials in the fluid printing material within feeding containers, feeding pipelines, and/or the print head, uncontrolled pressures in the feeding pipelines and/or the print head, and irregular and inconsistent flow rates of fluid printing material into the print head, among other problems and drawbacks. Movement of the print head during a continuous printing and continuous material feeding process can then exacerbate these problems and also give rise to additional issues.

The various embodiments disclosed herein serve to provide substantially constant flow rates, substantially constant pressures, and substantially consistent homogenous material mixtures of fluid printing materials into the print head regardless of print head movement during printing. Providing these consistent and reliable features of the fluid printing material can result in longer continuous print times and the ability to print larger and more complex objects. For example, providing constant flow rate and pressure of fluid printing material into the print head can allow for the printing of tall objects over three meters in height as the print head changes elevations during printing without a significant loss of material pressure or flow in the print head.

These results can be accomplished by way of a number of features that combine to ensure the continuous mixing and circulation of the complex fluid printing material, as well as features that can adjust the pressure and flow rate of the fluid printing material in the feed line to the print head based on changing dynamic conditions during continuous printing and feeding of the fluid printing material. For example, direct and return pipelines can form a closed loop system that ensures constant material circulation at all times, as stoppages in the flow of material tend to result in sedimentation and delamination of the complex material. The fluid printing material can also be constantly mixed at all times within a feeding tank. Continuous mixing and circulation of the fluid printing material can maintain good material conditions even when there is zero material consumption, such as during scheduled or emergency shut downs of the printer. The disclosed continuous feeding systems can also be flexible enough to be used with feeding tanks or containers of various volumes (e.g., 50 liters to several tons), as well as constant circulation systems that allow for pressure and flow controls at print heights of 5 meters or more.

Although various embodiments disclosed herein discuss continuous feeding systems designed for supplying fluid printing material within or to a 3D printing system, it will be readily appreciated that the disclosed features, apparatuses, systems, and methods can also be used for continuously feeding complex and highly viscous fluid materials in contexts outside of 3D printing applications. Furthermore, while the various embodiments disclosed herein discuss 3D printing with respect to buildings and building elements and components, it will be readily appreciated that the disclosed systems and methods can similarly be used for any relevant type of 3D printing and any 3D-printed object. For example, the disclosed systems and methods can be used for the production of 3D printing based models, figures, and other items that are not for use in building construction. Other applications, arrangements, and extrapolations beyond the illustrated embodiments are also contemplated.

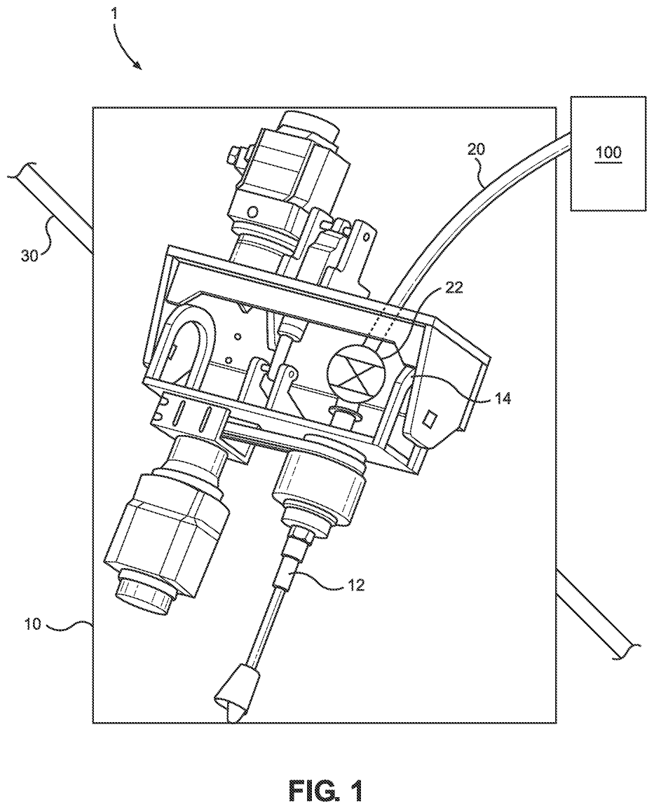

Referring first to FIG. 1, an example print head of a 3D printing system is illustrated in front perspective view. 3D printing system 1 can include a moveable print head 10 having an extruding system 12, a positioning system 14, a curing system (not shown) and a feedback system (not shown) having one or more sensors and processors, among other possible well-known 3D printing components. In various embodiments, some components of these systems may be located elsewhere from the print head 10. For example, one or more processors of the feedback system may be located outside of print head 10. Print head feed line 20 can provide complex and viscous fluid printing material from a continuous feeding system 100 into print head 10, such as directly into extruding system 12 where it can then be extruded through an inner passage and nozzle to be printed, such as in a continuous layer by layer 3D printing process. For example, print head 10 can move to create a desired 3D-printed building element geometry layer-by-layer, depositing material to form the base mass of a 3D-printed building element. In some arrangements, a print head valve 22 can be place before or within print head 10 to stop and allow the flow of fluid printing material from print head feed line 20 into extruding system 12.

Print head 10 can be coupled to a gantry system 30 that can be constructed to allow the print head to be moved in a variety of directions during a continuous 3D printing process, as will be readily appreciated by those of skill in the art. As such, print head feeding line 20 can form flexible tubing at or near print head 10 to allow for greater flexibility in movements of the print head. In some arrangements, gantry system 30 and print head 10 can be arranged such that the print head can change elevations during a printing process. Further details regarding 3D printing building elements using a movable print head can be found in U.S. Pat. No. 11,619,039, titled “THREE-DIMENSIONAL PRINTING BUILDING COMPONENTS AND STRUCTURES,” and U.S. patent application Ser. No. 17/219,866, titled “THREE-DIMENSIONAL PRINTING HEAD WITH ADJUSTABLE PRINTING ANGLE,” both of which are hereby incorporated by reference in their entireties herein. It will be readily appreciated that 3D printing system 1 and movable print head 10 are just illustrative examples of the types of printing systems and print heads that can be used with the disclosed continuous feeding systems, and that other variations and types of printing systems and print heads can also be used.

Elevation changes or vertical movement of print head 10 during a continuous 3D printing process can tend to result in natural pressure changes in the fluid printing material flowing through feed line 20, which can then give rise to changes in flow rate as well, as will be readily appreciated. This tendency and other issues with feeding a complex and highly viscous fluid printing material into a moving print head of an overall 3D printing system can be overcome through the various features and details set forth below with respect to continuous feeding system 100.

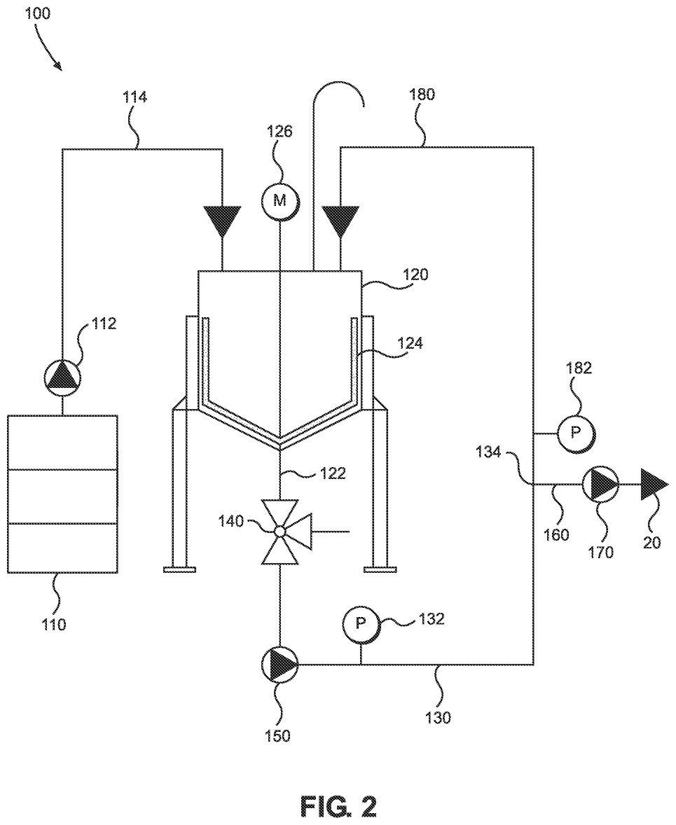

Moving to FIG. 2, a schematic diagram is provided of an example continuous feeding system for 3D printing. In particular, continuous feeding system 100 can be used with an overall 3D printing system having a print head that continuously extrudes fluid printing material while moving between variable elevations, such as example print head 10 noted above. Continuous feeding system 100 can include one or more material sources 110, feeding tank 120, main feeding line 130, first flow regulation device 140, second flow regulation device 150, secondary feeding line 160, third flow regulation device 170, and return line 180, among other possible components and features. Fluid printing material can be provided into print head feed line 20 at an end of continuous feeding system 100, which print head feed line can then feed the fluid printing material directly into the print head, as shown in FIG. 1 above.

One or more material sources 110, which can be material drums, for example, can hold fluid printing material itself or component materials that are used to form a complex and highly viscous fluid printing material in feeding tank 120. A source pump 112 can be coupled to each material source 110 to pump fluid printing material or a component thereof through a respective source line 114 into feeding tank 120. Feeding tank 120 can be configured to hold and dispense fluid printing material therefrom, such as by way of feeding tank outlet 122. An agitation component 124 can be located in feeding tank 120 and configured to agitate or mix the fluid printing material continuously within the feeding tank. Motor 126 can be configured to drive agitation component 124. In some arrangements, agitation component 124 can be a mixing blade and motor 126 can be a mixing blade motor coupled to and configured to rotationally drive the mixing blade, although other types of agitation, mixing, and drive components can be used. Other aspects of these components are provided in greater detail below.

Main feeding line 130 can be coupled to feeding tank outlet 122 and configured to pass fluid printing material from feeding tank outlet 122 therethrough. First flow regulation device 140 can be located before or along main feeding line 130 and can be configured to stop and to allow the flow of the fluid printing material through the main feeding line. In some arrangements, first flow regulation device 140 can be a ball valve, although other valve types or flow regulation devices can alternatively be used. Second flow regulation device 150 can also be located along main feeding line 130 and can be configured to alter the flow rate of the fluid printing material passing through the main feeding line. In some arrangements, second flow regulation device 150 can be a main pump, such as a progressive cavity pump, although other pump types or flow regulation devices can alternatively be used. In some arrangements, main pump or other second flow regulation device 150 can be located downstream of first flow regulation device 140, and portions of main feeding line 130 can exist before and after the main pump or other second flow regulation device 150. Both of the first and second flow regulation devices 140, 150 can be located directly below feeding tank 120.

Secondary feeding line 160 can be coupled to the main feeding line 130 and configured to deliver fluid printing material from the main feeding line toward or into a print head of an overall 3D printing system, such as by way of a print head feeding line 20. In some arrangements, print heading feed line 20 can be considered as part of secondary feeding line 160. Third flow regulation device 170 can be located along secondary feeding line 160 and can be configured to alter the flow rate of the fluid printing material passing through the secondary feeding line. In some arrangements, third flow regulation device 170 can be an intermediate pump, which can also be a progressive cavity pump, although other pump types or flow regulation devices can alternatively be used. For example, adjustable pressure regulators can be used as flow regulation devices while material can be pumped using constant output pumps.

Return line 180 can be coupled to main feeding line 130 and configured to deliver excess fluid printing material from the main feeding line back into feeding tank 120. A splitting component 134 can be placed at an end of main feeding line 130 such that fluid printing material passing through the main feeding line can either be diverted into secondary feeding line 160 or continue into return line 180. In some arrangements, return line 180 can have a smaller inner diameter than main feeding line 130 for fluid pressure and flow purposes. As shown, main feeding line 130 and return line 180 can be arranged into a closed loop and operated such that a continuous flow of fluid printing material is achieved at all regions of lines 130, 160, and 180. Other aspects of these components are provided in greater detail below.

In various arrangements, a first pressure sensor 132 can be configured to detect fluid pressure within main feeding line 130 and a second pressure sensor 182 can be configured to detect fluid pressure within return line 180. First pressure sensor 132 can be located on main feeding line 130 downstream of the main pump or other second flow regulation device 150, while second pressure sensor 182 can be located on return line 180 just downstream of splitting component 134. Alternatively, or in addition, a pressure sensor can be located between splitting component 134 and the intermediate pump or other third flow regulation device 170. The output of the intermediate pump or other third flow regulation device 170 can then be adjusted based on the pressures that are sensed by the pressure sensors 132, 182, such that a substantially constant flow rate and pressure is maintained in the fluid printing material passing through the print head feed line 20 and into the print head.

This can be accomplished automatically by using a processing component in some arrangements. For example, a processing component (not shown) can be in communication with at least first pressure sensor 132, second pressure sensor 182, and the intermediate pump or other third flow regulation device 170. Such a processing component can be configured to receive automatically inputs from the pressure sensors 132, 182 and to adjust automatically an output of the intermediate pump or other third flow regulation device 170 based on the received inputs. The output of the third flow regulation device 170 can be adjusted based on one or more factors, such as minor changes in the material composition of the fluid printing material flowing through the feeding lines, as well as movements or changes in the elevation of the print head, which can be detected based on corresponding movements or changes in elevation of portions of main feeding line 130, secondary feeding line 160, and/or return line 180. For example, when the elevation of the print head rises during printing, then a greater output is needed from the third flow regulation device 170 in order to maintain the flow rate and pressure of the fluid printing material in the print head feed line 20.

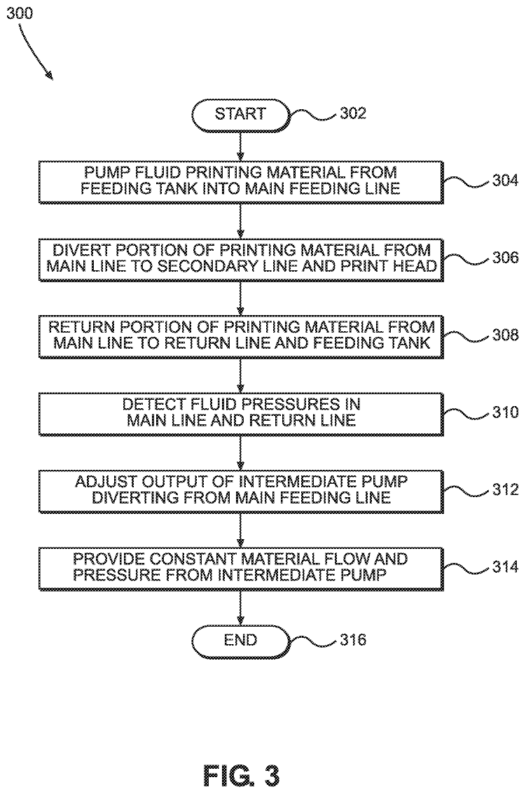

Turning next to FIG. 3, a flowchart of an example summary method of providing fluid printing material to a 3D printing system is provided. It will be readily appreciated that summary method 300 can be a high level method such that one or more steps can be omitted, various other steps can be added, and/or the order of steps can be altered as may be desired. Summary method 300 can relate primarily to maintaining consistent pressure and flow of fluid printing material into a print head of a 3D printing system, although other aspects of providing fluid printing material can also be included in some arrangements.

After a start step 302, a first process step 304 can involve pumping fluid printing material from a feeding tank into and through a main feeding line. This can be done using a main pump or one or more other suitable flow regulation devices located on the main feeding line. Step 304 can be performed automatically, such as by using a processing component configured for automated control of the main pump or other flow regulation device(s) on the main feeding line.

At the next process step 306, a first portion of the fluid printing material can be diverted from the main feeding line through a secondary feeding line and into a print head of the 3D printing system. This can be done using an intermediate pump or one or more other suitable flow regulation devices located on the secondary feeding line. Step 304 can be performed automatically, such as by using a processing component configured for automated control of the intermediate pump or other flow regulation device(s) on the secondary feeding line.

At a following process step 308, a second portion of the fluid printing material can be returned from the main feeding line through a return line and back into the feeding tank. Step 308 can be performed automatically, such as by way of the natural results of a system design where an end of the main feeding line includes a splitter that forces the flowing fluid printing material into both of the secondary feeding line and the return line, with the return line then feeding back into the feeding tank, for example.

At subsequent process step 310, fluid pressures can be detected in both the main feeding line and the return line. In some arrangements, fluid pressure can be detected in the secondary feeding line in lieu of or in addition to pressure detection in the return line. This can be accomplished by way of a pressure sensor located on each line where pressure is to be detected. Step 310 can be performed automatically, such as by using a processing component in communication with and configured to receive input from each pressure sensor.

At the next process step 312, an output of the intermediate pump or other suitable flow regulation device can be adjusted based on the detected fluid pressures in the main feeding line and the return line. This can be accomplished by increasing or decreasing power to the intermediate pump, for example. Step 312 can be performed automatically, such as by using a processing component configured for automated control of the intermediate pump or other flow regulation device. For example, the processing component can be configured to receive inputs regarding the detected fluid pressures and then increase or decrease the power output of the intermediate pump based on changes in the detected fluid pressures.

At subsequent process step 314, the fluid printing material can be provided continuously at a substantially constant flow rate and pressure from the intermediate pump to the print head by way of the adjusted output of the intermediate pump. This can involve changing the output of the intermediate pump in a way that accounts for other changed conditions in the system such that the flow rate and pressure remain constant rather than change as a natural result of the other changed conditions. Step 314 can be performed automatically, such as by way of the natural results of a system design where the intermediate pump output gets adjusted as needed to maintain a substantially constant material flow and pressure from the intermediate pump to the print head based on detected changes in system pressures and possibly other changed fluid material or system conditions. The method can then end at end step 316.

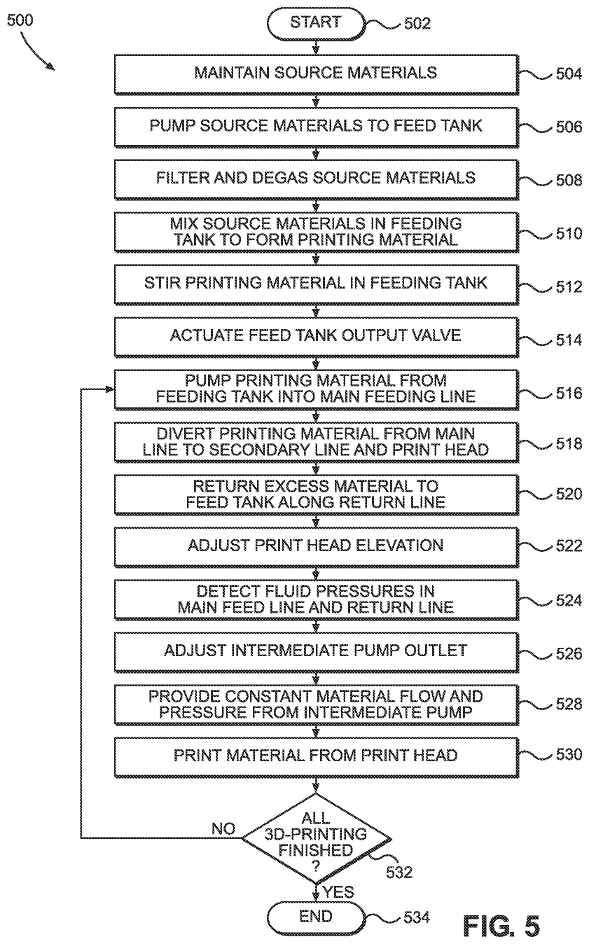

Again, method 300 can vary in some ways. For example, steps regarding maintaining and pumping source component materials into the feeding tank can be included, as well as steps regarding heating, filtering, degassing, and/or agitating the source materials, the composite fluid printing material, or both, at one or more locations in the process. Furthermore, some steps can be performed in a different order and some steps can be performed simultaneously. For example, all of steps 304-314 can be performed simultaneously during continuous and ongoing 3D printing and material feeding processes. Further possible process steps and detailed descriptions are provided below with respect to the detailed method set forth in FIG. 5.

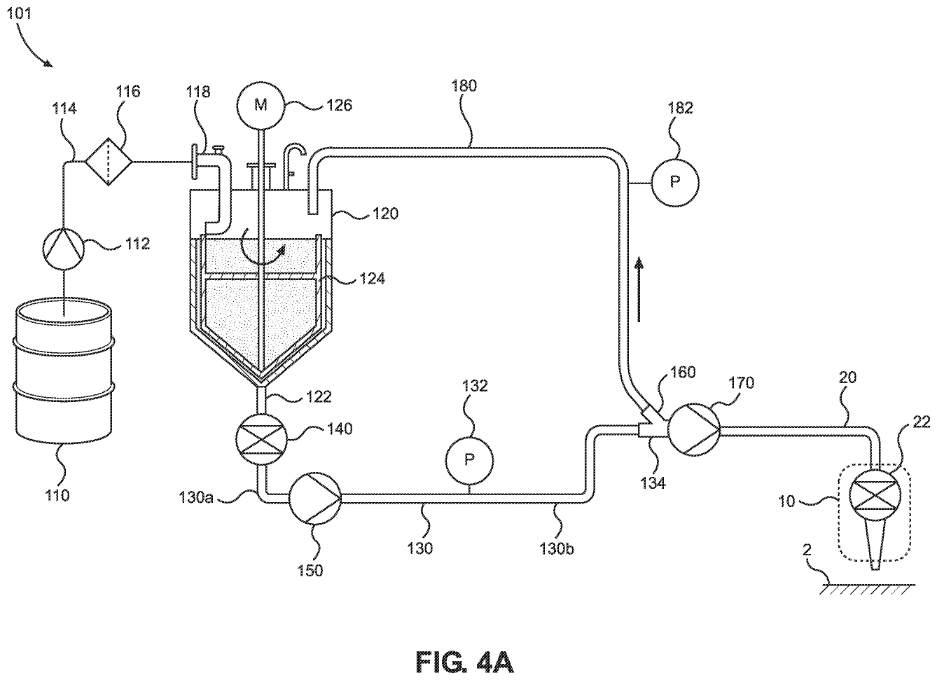

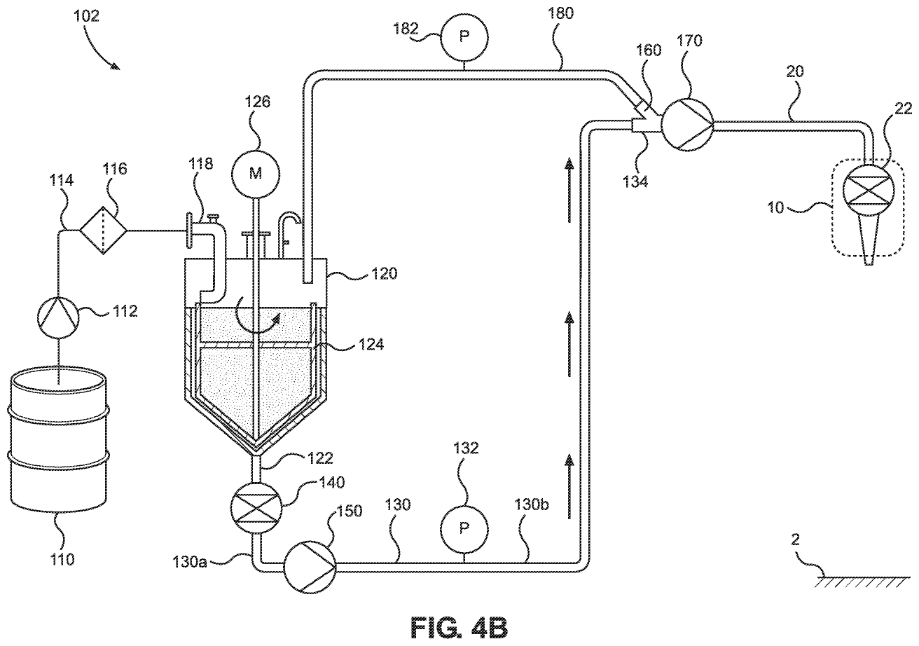

FIG. 4A provides a schematic diagram of an example continuous feeding system for 3D printing feeding a print head at a low elevation, while FIG. 4B provides a schematic diagram of the same continuous feeding system feeding the print head at a high elevation. It will be appreciated that the overall continuous feeding system shown in FIGS. 4A and 4B can be identical or substantially similar to continuous feeding system 100 depicted and described above. Configuration 101 shown in FIG. 4A can reflect relative positions of system components when print head 10 is at a low vertical elevation relative to ground 2, while configuration 102 shown in FIG. 4B can reflect relative positions of system components when print head 10 is at a high vertical elevation relative to ground 2. As noted above, a separate gantry arrangement (not shown) or other positioning system can be used to move print head 10 in various directions during a continuous 3D printing process, and such movement directions can include changes in vertical elevations.

Various components can remain stationary or at least in the same location during a continuous process involving the continuous feeding system while the print head moves and continuously prints the fluid printing material fed into it. These can include, for example, one or more material sources 110, source pump(s) 112, source line(s) 114, filter(s) 116, degasser(s) 118, feeding tank 120, feeding tank outlet 122, valve or other first flow regulation device 140, and main pump or other second flow regulation device 150, among other possible system items. Mixing blade or other agitation component 124 and agitation motor 126 can be in motion but remain in the same location during a continuous feeding process.

As shown in configuration 102 in FIG. 4B, several system components can move or flex to change location when print head 10 (along with print head valve 22 and any other print head components) moves to change its location between the low and high vertical elevations depicted in FIGS. 4A and 4B. These can include, for example, at least a portion of main feeding line 130, splitting component 134, secondary feeding line 160, intermediate pump or other third flow regulation device 170, print head feeding line 20, return line 180, and second pressure sensor 182, among other possible system items. To facilitate this flexibility in movement, some or all portions of the various feed lines can be formed from flexible tubing, with a sufficient amount of slack in each line being present to allow for all desired movements of print head 10. For example, all of secondary feeding line 160, print head feeding line 20, and return line 180 can be formed from flexible tubing. In some arrangements, a downstream portion 130b of main feeding line 130 can also be formed of flexible tubing, while an upstream portion 130a of the main feeding line can be a solid and stationary part of that feeding line. First pressure sensor 132 can be arranged to move with a flexible portion of main feeding line 130 or can remain with a stationary portion of the main feeding line. Other arrangements and features in the continuous feeding system can be made to facilitate flexibility of movement for print head 10.

In various arrangements, feeding tank 120 can have a cylindrical shape with a conical bottom, which can facilitate pumping material from the feeding tank using a pump located directly below the feeding tank. Feeding tank 120 can be a general industrial chemical reactor-mixer adapted for use as a supply vessel, and its volume can be chosen based on the specific work processes and needs for which the continuous feeding system is integrated. For example, when using source materials packed into 200 liter drums as material sources 110, it can be sufficient to use a feeding tank 120 having a 250 liter capacity. This can allow for fully accommodating one drum of source material while reserving a small amount of volume to allow for refilling of the supply tank. Types and densities of the source materials and mixed fluid printing materials can also be factors in choosing the right vessel to serve as a suitable feeding tank 120. Depending on various factors of a given system, feeding tank 120 can have a volume ranging from about 50 liters to several tons or more, although smaller and larger feeding tanks are also possible.

In some arrangements, the chemical reactor portion of feeding tank 120 and one or more source pumps 112 can be installed onto a single structural frame (not shown). Such a single structural frame can provide for a compact arrangement of system equipment components and parts while allowing for easy installation and maintenance processes. The single structural frame or other support arrangement can be placed onto one or more scales to monitor and control the filling level of the feeing tank. For example, one or more scales can monitor and determine the amount of source material transferred from material source(s) 110 into feeding tank 120 and can also provide an output for how much fluid printing material remains in the feeding tank during continuous material feeding and 3D printing processes. Each source pump 112 can be controlled based on how much source material has been detected by the scale as being input into feeding tank 120, while valve or other flow regulation device 140 can be controlled based on how much fluid printing material has left the tank by way output 122.

In various embodiments, agitation component 124 can be a mixing blade that rotates continuously to mix and agitate the materials in feeding tank 120. Such a mixing blade can be arranged such that the maximum gap between the edges of the blade and the cylindrical walls of feeing tank 120 is about 5 mm, although other gap dimensions are also possible. Mixing blade or other agitation component 124 can be driven by motor 126 at a rotational speed of up to about 35 rotations per minute, although this speed can vary based upon the properties of the fluid printing material being mixed and the size of feeding tank 120. For example, this rotational speed can be reduced for relatively larger sized feeding tanks with greater diameters. Motor 126 can have power sufficient to drive the mixing blade in a high viscosity liquid of up to 200,000 cPa or more, such as that which is inherent to fluid printing materials of interest.

Before entering feeding tank 120, various source materials can pass through one or more filters 116 to remove relatively large particulate matters from the source materials, which can include large pieces of polymerized material and its clots. Such filters can include a coarse 3 mm mesh material, for example, although other sizes and types of filters can also be used. Alternatively, or in addition, one or more filtration devices can also be incorporated within the mixing tank. One or more degassers 118 can be placed into feeding tank 120, and these can include slotted degassers configured to remove gas bubbles from the high viscosity fluid material being stirred or agitated in the feeding tank. Alternatively, or in addition, one or more degassers can also be incorporated into source line(s) 114.

As noted above, various feeding lines can be formed from flexible tubing, stationary piping, or a combination of both. Flexible tubing can include chemical resistant hoses, while stationary piping can include stainless steel pipes, for example. Other suitable materials are also possible. In some arrangements, return line 180 can have a smaller inner diameter than the inner diameters of main feeding line 130 and secondary feeding line 160. As noted above, one or both of second and third flow regulation devices 150, 170 can be progressive cavity pumps. One or both of these pumps can be single screw type volumetric pumps with frequency regulation, for example, although other suitable pump types can be used. In some embodiments, main pump 150 can be located directly below feeding tank 120, while intermediate pump 170 can be located on the Z axis of print head 10.

In addition to controlling for substantially constant material flow and pressure in print head feed line 20 and substantially continuous movement of all fluid printing material within the system, continuous feeding system 100 can also include one or more temperature controls for the subject fluid printing material, source materials, or both. For example, all barrels and material sources with fluid printing materials and source materials can be stored in a temperature-controlled warehouse to ensure suitable levels of material temperature control. In addition, a suitable temperature controlled chamber can be located near the place of printing or other material usage, such as where transportation to a printing location can significantly change material temperatures, or if additional temperature controls are desired for any reason.

For example, at low ambient temperatures primary temperature controls can be carried out in a warehouse up to about 20-25 degrees Celsius, since energy consumption can be negligible at these temperatures. At the printing location, the materials can then separately be heated up to about 30 degrees in a separate chamber. After temperature control, the barrels or other material sources can be placed into a special restoring station that can operate to homogenize the materials. Such a restoring station can be automated, manually operated, or some combination thereof.

From a barrel or other material source 110, material can then be pumped into feeding tank 120, such as by using a pneumatic piston pump as source pump 112. Thermally controlled heating pads can be attached to feeding tank 120 to ensure the temperature of the material inside the feeding tank. One or more heating pads or thermal jackets can also be placed around various other system components to maintain temperature control as material flows through the system. This can include one or more of the source line, feeding lines, return line, and each of the flow regulation devices, for example. A material drum heater can also be used to control temperatures at the material drum or other material source(s) 110. In some arrangements, the print head 10 can also have its own thermal control system, casing, and heating installations to maintain a constant temperature of the fluid printing material during a printing process. Other components and features can also be used to control or maintain material temperatures as may be desired.

Lastly, FIG. 5 illustrates a flowchart of an example detailed method of 3D printing a building component using a variable elevation print head and a continuous flow of fluid printing material. Method 500 can be a detailed version of method 300 set forth above, with various steps and details being interchangeable and/or removable from one or both methods. As in the above method 300, various steps of method 500 can be performed in different orders and/or simultaneously, such as during a continuous 3D printing process. Furthermore, some or all steps may be repeated as desired in varying orders until all desired 3D printing is finished.

After a start step 502, a first process step 504 can involve maintaining one or more source materials. Such source materials can be components used to form a final composite fluid printing material mixture or can be the final mixture itself in some arrangements. As noted above, the source material can be stored in one or more material drums or other sources that are configured to provide these sources for delivery into a feeding tank. Step 504 can be performed automatically, such as by using a processing component configured for automated control of maintaining materials in the material sources prior to delivery into the feeding tank.

At a subsequent process step 506, the one or more source materials can be pumped through one or more source lines into the feeding tank. This can be done using a source pump for each material source and source line, and can include one or more pneumatic piston pumps, for example. Step 506 can be performed automatically, such as by using a processing component configured for automated control of each source pump on each source line.

Process step 508 can then involve filtering the one or more source materials to remove large particulate matter as well as degassing the one or more source materials, the fluid printing material in the feeding tank, or both. This can involve one or more filters on the source line(s) and/or in the feeding tank, as well as one or more slotted degassers in the feeding tank and/or on the source line(s), for example. Step 508 can be performed automatically, such as by the natural result of flowing source materials and/or mixed fluid printing materials through previously installed filter(s) and degasser(s).

At the next process step 510, the one or more source materials can be mixed or in the feeding tank to form the fluid printing material. In the event that the source material is an already finished fluid printing material, then this step can be skipped. Step 510 can be performed automatically, such as by using a processing component configured for automated control of a rotational motor that drives a moving mixing blade within the feeding tank.

Process step 512 can then involve stirring or otherwise agitating the fluid printing material in the feeding tank. This can be done to keep the fluid printing material moving within the feeding tank to prevent delamination or other issues with stagnation in a non-moving complex and viscous fluid printing material. Step 512 can be performed automatically, such as by similarly using a processing component configured for automated control of a rotational motor that drives the moving mixing blade within the feeding tank.

At a following process step 514, a feeding tank output valve can be actuated. As noted above, such a valve can be coupled to an outlet of the feeding tank to allow the fluid printing material to pass from the feeding tank therethrough. Step 514 can be performed automatically, such as by using a processing component configured for automated control of the output valve when simultaneous continuous material feeding and continuous 3D printing processes are to begin.

Process step 516 can then involve pumping fluid printing material from the feeding tank into and through a main feeding line. This can be done using a main pump or one or more other suitable flow regulation devices located on the main feeding line. Step 516 can be performed automatically, such as by using a processing component configured for automated control of the main pump on the main feeding line.

At subsequent process step 518, a first portion of the fluid printing material can be diverted from the main feeding line through a secondary feeding line and into a print head of the 3D printing system. This can be done using an intermediate pump or one or more other suitable flow regulation devices located on the secondary feeding line. Step 518 can be performed automatically, such as by using a processing component configured for automated control of the intermediate pump on the secondary feeding line.

Process step 520 can then involve returning excess fluid printing material from the main feeding line through a return line and back into the feeding tank. Step 520 can be performed automatically, such as by way of the natural results of a system design where an end of the main feeding line includes a splitter that forces the flowing fluid printing material into both of the secondary feeding line and the return line, with the return line then feeding back into the feeding tank, for example.

At the next process step 522, the elevation of the print head can be adjusted. This can involve any suitable automated 3D printing process where the print head is moved during a continuous printing operation, such as that which is set forth in the references incorporated above, for example.

Process step 524 can then involve detecting fluid pressures in both the main feeding line and the return line. Again, fluid pressure can be detected in the secondary feeding line in lieu of or in addition to pressure detection in the return line in some cases. This can be accomplished by way of a pressure sensor located on each line where pressure is to be detected. Step 524 can be performed automatically, such as by using a processing component in communication with and configured to receive input from each pressure sensor.

At a following process step 526, an output of the intermediate pump or other suitable flow regulation device can be adjusted based on the detected fluid pressures in the main feeding line and the return line. This can be accomplished by increasing or decreasing power to the intermediate pump, for example. Step 526 can be performed automatically, such as by using a processing component configured for automated control of the intermediate pump or other flow regulation device. For example, the processing component can be configured to receive inputs regarding the detected fluid pressures and then increase or decrease the power output of the intermediate pump based on changes in the detected fluid pressures.

Process step 528 can then involve providing the fluid printing material continuously at a substantially constant flow rate and pressure from the intermediate pump to the print head by way of the adjusted output of the intermediate pump. This can involve changing the output of the intermediate pump in a way that accounts for other changed conditions in the system such that the flow rate and pressure remain constant rather than change as a natural result of the other changed conditions. Step 528 can be performed automatically, such as by way of the natural results of a system design where the intermediate pump output gets adjusted as needed to maintain a substantially constant material flow and pressure from the intermediate pump to the print head based on detected changes in system pressures and possibly other changed fluid material or system conditions.

At the next process step 530, the fluid printing material can be printed from the print head. This can involve any suitable automated 3D printing process where the fluid printing material is extruded from an extruder and nozzle arrangement in the print head, such as that which is set forth in the references incorporated above, for example.

At subsequent decision step 532, an inquiry can be made as to whether all desired 3D printing is finished. If not, then the method can revert to process step 516 and some or all steps can be repeated for further 3D printing. If all desired 3D printing is finished at decision step 532, however, then the method can end at end step 534.

Again, all steps can be performed simultaneously and in automated fashion, such that fluid printing material can be continuously fed into a print head that continuously prints the fluid printing material while moving all at the same time. In addition, not all steps will be needed for some processes, such that various condensed versions of method 500 can be used. Furthermore, the order of steps can be altered as may be practical or optimal for a given continuous material feeding and 3D printing process. For example, the method can revert to step 504 from step 532 such that all steps can be repeated continuously, with the possible exception of step 514 that may only need to be performed once. Additional steps or functions can also be performed as may be necessary. Such additional steps can include heating the fluid printing material at one or more locations, for example, among other possible process steps.

Although the foregoing disclosure has been described in detail by way of illustration and example for purposes of clarity and understanding, it will be recognized that the above described disclosure may be embodied in numerous other specific variations and embodiments without departing from the spirit or essential characteristics of the disclosure. Certain changes and modifications may be practiced, and it is understood that the disclosure is not to be limited by the foregoing details, but rather is to be defined by the scope of the appended claims.

What is claimed is:

1. A three-dimensional (“3D”) printing system, the system comprising:
a print head configured to extrude fluid printing material during a 3D printing process, wherein the print head is further configured to move in multiple directions including changing elevation while continuously extruding the fluid printing material; and
a continuous feeding system coupled to the print head and configured to supply the fluid printing material into the print head continuously as the print head moves and extrudes the fluid printing material, wherein the continuous feeding system includes:
a feeding tank configured to hold and dispense the fluid printing material,
a main feeding line coupled to an outlet of the feeding tank and configured to pass the fluid printing material from the outlet,
a first flow regulation device located along the main feeding line, wherein the first flow regulation device is configured to stop and to allow the flow of the fluid printing material through the main feeding line,
a second flow regulation device located along the main feeding line, wherein the second flow regulation device is configured to alter the flow rate of the fluid printing material passing through the main feeding line,
a secondary feeding line coupled to the main feeding line and configured to deliver fluid printing material from the main feeding line into the print head,
a third flow regulation device located along the secondary feeding line, wherein the third flow regulation device is configured to alter the flow rate of the fluid printing material passing through the secondary feeding line, and
a return line coupled to the main feeding line and configured to deliver excess fluid printing material from the main feeding line back into the feeding tank.

2. The system of claim 1, wherein the system is configured for the printing of 3D-printed building elements.

3. The system of claim 1, wherein the first flow regulation device is a valve, and the second and third flow regulation devices are variable power progressive cavity pumps.

4. The system of claim 1, wherein at least a portion of the main feeding line includes flexible tubing that is configured to move based on movement of the print head.

5. The system of claim 1, wherein the continuous feeding system further includes:
a first pressure sensor configured to detect a pressure of the fluid printing material passing through the main feeding line, and
a second pressure sensor configured to detect a pressure of the fluid printing material passing through the return line.

6. The system of claim 5, wherein the continuous feeding system further includes:
a processing component in communication with at least the first pressure sensor, the second pressure sensor, and the third flow regulation device, wherein the processing component is configured to receive automatically inputs from the first and second pressure sensors and to adjust automatically an output of the third flow regulation device based on the received inputs.

7. The system of claim 6, wherein automatic adjustment of the output of the third flow regulation device results in the fluid printing material being continuously supplied into the print head at a substantially constant pressure and flow rate despite movement of the print head.

8. The system of claim 1, wherein the feeding tank has a conically shaped bottom and has a volume of at least 50 liters.

9. The system of claim 1, wherein the continuous feeding system further includes:
a mixing blade located within the feeding tank, wherein the mixing blade is configured to mix the fluid printing material continuously within the feeding tank during the 3D printing process, and
a mixing blade motor coupled to and configured to rotationally drive the mixing blade, wherein combined operation of the print head, the second flow regulation device, the third flow regulation device, the mixing blade, and the mixing blade motor result in the continuous movement of substantially all fluid printing material in the print head, the feeding tank, the main feeding line, the secondary feeding line, and the return line during the 3D printing process.

10. The system of claim 1, wherein the continuous feeding system further includes:
one or more source lines configured to deliver one or more component materials of the fluid printing material from one or more sources into the feeding tank, and
one or more source pumps configured to pump the one or more component materials through the one or more source lines.

11. The system of claim 10, wherein the one or more sources include a material drum, and wherein the continuous feeding system further includes:
a material drum heater configured to heat the material drum,
one or more heating components configured to heat one or more additional continuous feeding system components between the material drum and the print head, and
one or more thermal insulation components configured to thermally insulate one or more additional continuous feeding system components between the material drum and the print head to maintain a heated temperature of the fluid printing material.

12. The system of claim 10, wherein the continuous feeding system further includes:
one or more filters configured to filter large particles from the one or more component materials before the one or more component materials are delivered into the feeding tank, and
a degasser located within the feeding tank and configured to remove gas bubbles from the fluid printing material within the feeding tank.

13. A continuous feeding system configured to supply fluid printing material within a three-dimensional (“3D”) printing system, the continuous feeding system comprising:
a feeding tank configured to hold and dispense the fluid printing material;
a main feeding line coupled to an outlet of the feeding tank and configured to pass the fluid printing material from the outlet;
a valve located along the main feeding line, wherein the valve is configured to stop and to allow the flow of the fluid printing material through the main feeding line;
a main pump located along the main feeding line, wherein the main pump is configured to alter the flow rate of the fluid printing material passing through the main feeding line;
a secondary feeding line coupled to the main feeding line and configured to deliver fluid printing material from the main feeding line into a print head of the 3D printing system;
an intermediate pump located along the secondary feeding line, wherein the intermediate pump is configured to alter the flow rate of the fluid printing material passing through the secondary feeding line; and
a return line coupled to the main feeding line and configured to deliver excess fluid printing material from the main feeding line back into the feeding tank.

14. The continuous feeding system of claim 13, wherein the continuous feeding system is configured to supply the fluid printing material continuously at a substantially constant flow and pressure to the print head while the print head extrudes the fluid printing material therefrom continuously as it moves between different elevations.

15. The continuous feeding system of claim 14, wherein at least a portion of the main feeding line, at least a portion of the return line, or both include flexible tubing that is configured to move based on movement of the print head.

16. The continuous feeding system of claim 13, further including:
a first pressure sensor configured to detect a pressure of the fluid printing material passing through the main feeding line;
a second pressure sensor configured to detect a pressure of the fluid printing material passing through the return line;
a processing component in communication with at least the first pressure sensor, the second pressure sensor, and the intermediate pump, wherein the processing component is configured to receive automatically inputs from the first and second pressure sensors and to adjust automatically an output of the intermediate pump based on the received inputs.

17. The continuous feeding system of claim 13, further including:
an agitation component located within the feeding tank, wherein the agitation component is configured to agitate or mix the fluid printing material continuously within the feeding tank during the 3D printing process;
one or more source lines configured to deliver one or more component materials of the fluid printing material from one or more sources into the feeding tank, wherein at least one of the sources is a material drum;
one or more source pumps configured to pump the one or more component materials through the one or more source lines;
a material drum heater configured to heat the material drum;
one or more heating components configured to heat one or more additional continuous feeding system components between the material drum and the print head;
one or more thermal insulation components configured to thermally insulate one or more additional continuous feeding system components between the material drum and the print head to maintain a heated temperature of the fluid printing material;
one or more filters configured to filter large particles from the one or more component materials before the one or more component materials are delivered into the feeding tank; and
a degasser located within the feeding tank and configured to remove gas bubbles from the fluid printing material within the feeding tank.

18. A method of providing fluid printing material to a three-dimensional (“3D”) printing system, the method comprising:
pumping automatically fluid printing material from a feeding tank through a main feeding line using a main pump located on the main feeding line;
diverting automatically a first portion of the fluid printing material from the main feeding line through a secondary feeding line and into a print head of the 3D printing system using an intermediate pump located on the secondary feeding line;
returning automatically a second portion of the fluid printing material from the main feeding line through a return line and back into the feeding tank;
detecting automatically fluid pressures in the main feeding line and the return line;
adjusting automatically an output of the intermediate pump based on the detected fluid pressures in the main feeding line and the return line; and
providing automatically the fluid printing material continuously at a substantially constant flow and pressure from the intermediate pump to the print head by way of the adjusted output.

19. The method of claim 18, wherein the fluid printing material is provided continuously at a substantially constant flow and pressure while the print head extrudes the fluid printing material continuously therefrom as it moves between different elevations.

20. The method of claim 18, further comprising the steps of:
maintaining one or more source materials used to form the fluid printing material;
pumping the one or more source materials through one or more source lines into the feeding tank;
filtering the one or more source materials to remove large particulate matter;
degassing the one or more source materials, the fluid printing material in the feeding tank, or both;
mixing the one or more source materials in the feeding tank to form the fluid printing material;
stirring the fluid printing material in the feeding tank;
actuating an output valve coupled to an outlet of the feeding tank to allow the fluid printing material to pass from the feeding tank therethrough;
extruding the fluid printing material from the print head; and
adjusting an elevation of the print head while extruding the fluid printing material therefrom.
